(19) United States
(12) Patent Application Publication
(10) Pub. No.: US 2004/0220935 A1
(43) Pub. Date: Nov. 4, 2004

(54) System, method and medium for utilizing digital watermarks in instructional material

(75) Inventors: Tammy Marie McGraw, Beckley, WV (US); Jonathan Alan Caldwell, Charleston, WV (US); E. Jane Copley, Hurricane, WV (US)

Correspondence Address: WILMER CUTLER PICKERING HALE AND DORR LLP, THE WILLARD OFFICE BUILDING, 1455 PENNSYLVANIA AVE, NW, WASHINGTON, DC, 20004, US

(73) Assignee: Appalachia Educational Laboratory, Inc., Charleston, WV

(21) Appl. No.: 10/424,714

(22) Filed: Apr. 29, 2003

(51) Int. Cl. G06F 17/00

(52) U.S. Cl. 707/10

(57) ABSTRACT

A system, method and medium that embeds an imperceptible or substantially imperceptible watermark in an image on a page of instructional material. Upon using an optical reading device to read the watermark, a computer can launch, for example, an application program used to provide, for example, context sensitive information, one or more learning assessment activities, and/or information for the physically impaired, and/or redirect a user to an educationally relevant web page as directed by the watermark.

### BACKGROUND OF THE INVENTION

1. Field of the Invention

The present invention relates generally to the field of digital watermarking and, more particularly, to a system, method, and medium for utilizing digital watermarks in educational and/or instructional material to provide and/or facilitate a customized and/or enhanced computer-assisted learning environment.

2. Background Description

Few resources are more prevalent in schools than textbooks. In many cases, however, textbooks may not adequately address the needs of students and/or teachers. For example, outdated information is common due to the nature of textbook adoption cycles, and the information often can otherwise be ill-suited to curricula and/or assessments. Further, printed textbooks may contain inaccuracies that can remain in use for several years.

Textbook development is largely driven by market demand. Accordingly, states with large student populations typically have the greatest impact on textbook development. Some states (e.g., Texas and Maine) are experimenting with replacing textbooks with laptop computers. However, equipping every teacher and student with a laptop computer to access the World Wide Web (WWW), with its vast resources, can be burdensome to teachers already strapped for time, making it difficult for teachers to locate the most educationally appropriate information and effective accommodation tools for their students.

E-books (i.e., a single-purpose device that displays reading materials in ways similar to traditional books) can also be used in conjunction with or in lieu of laptop computers to supplement and/or replace textbook learning. Several e-book devices are available (e.g., the eBookMan® (by Franklin Electronic Publishers, Burlington, N.J.), goReader (by goReader, Inc., Chicago, Ill.), and eBook™ (by Gemstar Development Corporation, Pasadena, Calif.)). However, the proprietary file format inherent in many e-book devices generally makes them a less-attractive option than, for example, laptop computers. Furthermore, the titles currently available for many e-books are not particularly well suited for K-12 classrooms. Recent studies indicate that students read 25% to 40% slower using electronic media. Other issues abound. For example, users of printed books can lend them to a friend and/or resell them. On the other hand, certain technological safeguards have made sharing e-books difficult, and have made resale virtually impossible.

At the present, e-books do not appear to be replacing print media but rather supplementing it, indicating that conventional print-based textbooks are likely to remain dominant in classrooms for some time. From a school or classroom management perspective, another compelling reason to refrain from completely replacing conventional textbooks with an electronic device (e.g., laptop computers and/or e-books), is that printed textbooks are reliable even when technology fails. Bandwidth requirements, equipment maintenance and support, and network stability already weigh heavily on schools. These limitations must be considered before greater reliance is placed on the exclusive use of electronic media.

With regard to information technology and electronic media, teachers generally help students learn how to locate and access information from the Internet. However, teaching students to locate appropriate information is not as easy as it might seem. Currently, there are more than 2 billion pages on the WWW, with millions of new pages being added daily. Even the best search engines may retrieve information that could mislead and/or confuse students who do not have requisite skills to assess accuracy.

In view of the vast amount of information available over the Internet, it has been determined that there are significant advantages to utilizing information technology in connection with conventional textbooks having steganographically embedded indicia. One example of the utilization of information technology in connection with non-steganographic indicia is found in U.S. Pat. No. 6,076,733, which is incorporated herein by reference. U.S. Pat. No. 6,076,733 discloses a system that comprises a bar code symbol reader that is programmed for reading bar code symbols encoded with Uniform Resource Locators (URLs) specifying the location of HyperText Markup Language-encoded (HTML-encoded) documents of the WWW. In response to reading a URL-encoded bar code symbol on one or more pages of a printed WWW-site guide, the bar code symbol reader produces data representative of the URL.

One problem with the bar code approach, however, is that bar codes are visually conspicuous and would therefore be distracting when used on, for example, a tangible medium (e.g., a page of text) that is to be utilized in an academic and/or an educational environment or context. There is, therefore, a need for a scheme that provides a page of text utilized in an academic and/or educational environment comprising steganographically embedded indicia corresponding to, for example, a URL that can be read by an optical reader, scanner and/or similar device/reader (hereinafter optical reader) that, when read by the optical reader, links the user to information content associated with the URL.

There also exists a general need for a scheme that provides a page of text utilized within an academic and/or educational environment comprising steganographically embedded indicia that can be utilized to access, via an optical reader, any of a plurality of context sensitive and/or educationally relevant application programs, educational tools, communication tools, and/or instructional material (any of which can be stored locally or on a network) that provide and/or facilitate a customized and/or enhanced computer-assisted learning environment in which the need for a cumbersome user interface eliminated, thereby benefiting and serving the needs of many students, including those with physical and/or cognitive limitations.

In addition, there also exists a need for a scheme that provides a page of text utilized within an academic and/or educational environment comprising steganographically embedded indicia that can be utilized to access, via an optical reader, any of a plurality of application programs and/or other educational tools that can provide remedial, advanced, or alternative information or activities (in addition to those provided in the page(s) of text) to supplement and/or enhance the user's learning experience.

Other advantages and objectives of the present invention will become apparent from consideration of the detailed descriptions, drawings, and claims which follow.

### SUMMARY OF INVENTION

In contrast to conventional schemes that utilize visually conspicuous and potentially distracting barcodes, the present invention utilizes an imperceptible or substantially imperceptible (hereinafter imperceptible) digital watermark (e.g., digital data embedded imperceptibly/steganographically, or substantially imperceptibly, in traditional and digital media content, including, for example, photographic and/or artistic images, text, and the like) that is embedded in, for example, an image and/or shaded text that is displayed within a page of educational and/or instructional material to provide and/or facilitate a customized and/or enhanced computer-assisted learning environment.

The digital watermark can be used, for example, to display a web page and/or launch any of a plurality of application programs and/or other educational tools that can provide context sensitive information and/or remedial, advanced, and/or alternative information or activities to supplement and/or enhance a user's learning experience. For example, at least one embodiment of the present invention contemplates that customization can be for learners at various skill levels and/or requiring learning accommodation. In this regard, links are not confined to the WWW, but also enable access to information stored within, for example, a standalone personal computer. The “interactive text” (e.g., physical medium) in accordance with the present invention thus connects enhancements to the printed text to launch, for example, educationally appropriate information, assessments, applications, and/or accommodation tools that can be customized for students with differing abilities and learning needs.

It is therefore a feature and advantage of the present invention to enable users to link via a digital watermark and optical reader to, for example, a context sensitive and/or educationally appropriate web site without the use of a cumbersome user interface (e.g., without the student having to type in a URL or having to locate a URL via a bookmark), thereby benefiting and serving the needs of many students, including those with physical and/or cognitive limitations.

It is another feature and advantage of the present invention to enable users to link via a digital watermark and optical reader to a context sensitive and/or educationally appropriate web site without having to explore the holdings of information on the WWW (i.e., without having to “surf” and/or search the WWW).

It is a yet another feature and advantage of the present invention to utilize a digital watermark to display, for example, a web page and/or launch, for example, any of a plurality of application programs and/or other educational tools that can provide context sensitive information and/or remedial, advanced, or alternative information or activities to supplement and/or enhance the user's learning experience.

It is a still another feature and advantage of the present invention to enable users to link via a digital watermark and optical reader to a context sensitive and/or educationally appropriate web site, application program, and/or educational tool in a manner that retains salient aspects of a conventional text, thereby providing substantially instantaneous and convenient access to, for example, dynamic content, assessments, applications, and/or communication tools.

It is a further feature and advantage of the present invention to provide a physical medium (e.g., an interactive text) that does not require the displacement of conventional textbook production methods, thereby facilitating adoption by the educational/instructional publishing industry.

In accordance with at least one embodiment of the present invention, watermarking technology commercially available from, for example, Digimarc Corporation, Tualatin, Oreg., can be used to embed a digital watermark in, for example, an image on a page of instructional and/or educational material, thereby providing “interactive text.” Specifically, at least one embodiment of the present invention can utilize Digimarc MediaBridge™ technology to create an imperceptible digital watermark comprising, for example, Extensible Markup Language-based (XML-based) coding embedded in a graphic or other media element. With the aid of an optical reader, such as a conventional PC-camera or similar device, operatively connected to a computer, Digimarc MediaBridge™ software reads the watermark, activates, for example, a Web browser (if required or not already activated), and links the user to a Web site specified by the digital watermark.

Consider one example in the area of biological science or public health. In accordance with at least one embodiment of the present invention, interactive text is an “extension” of (or supplement to) the information provided in conventional text. By using an optical reader, supplementary information in the form of audio, video, or other multimedia-based digital formats can also be dynamically linked to the printed page with an imperceptible digital watermark, thereby creating an interactive learning environment of the most current, reliable, and accurate information possible in a learning community that reaches beyond the geographic boundaries of a classroom, school or community.

In accordance with at least one embodiment of the present invention, students exploring the immune system can, via a digital watermark and optical reader, link to and use information created by content experts such as the National Cancer Institute and/or the National Institutes of Health. Students can also, for example, view videos to better understand the experience and need for using an iron lung, and/or listen, for example, to interviews of survivors of major epidemics. Students, via a digital watermark and optical reader, can pay a virtual (e.g., online) visit to, for example, the Howard Hughes Medical Institute, and participate in a virtual lab simulation to better understand the role of antibodies. Students studying Acquired Immune Deficiency Syndrome (AIDS) and Human Immunodeficiency Virus (HIV) can, via a digital watermark and optical reader, use current emperical data provided by, for example, the Centers for Disease Control (CDC) and/or the AIDS Education Global Information System (AEGIS) for their own analysis and study.

In accordance with at least one embodiment of the present invention, the interactive instructional material is, however, more than a gateway to Web-based content. A graphical palette containing icons embedded with one or more digital watermarks can provide quick access to a suite of learning tools that allow students to apply concepts and practice skills. For example, a student can instantly check for understanding by pointing an optical reader (or presenting the digital watermark to the optical reader) to an image representing an assessment activity (e.g., a series of text-based questions and/or a simulation allowing the student to respond to a few quick questions while receiving immediate feedback), whereby the embedded watermark causes an assessment to be launched. The teacher can also receive information regarding the user's (e.g., a student's) assessment and exploration of the content. Differentiated instruction is also possible as each student can explore various layers of content appropriate for his or her needs, interests and/or abilities. For example, a hearing-impaired student studying composers might access different information (e.g., a visual pattern of repeating color that would represent tone) than students with unimpaired hearing.

### BRIEF DESCRIPTION OF THE DRAWINGS

The Detailed Description including the description of various features of the invention will be best understood when read in reference to the accompanying figures wherein:

FIG. 1 is a schematic of a network that can be used with at least one embodiment of the present invention;

FIG. 2 is a schematic diagram of an imperceptible digital watermark-driven system according to a generalized embodiment of the present invention;

FIG. 3 is a flow chart setting forth the steps carried out during the execution of at least one embodiment of the present invention;

FIG. 4A is an example of a first page of instructional material containing an image and a plurality of icons, each of which can be embedded with an imperceptible watermark;

FIG. 4B is an example of a second page of instructional material containing an image and a plurality of icons, each of which can be embedded with an imperceptible watermark;

FIG. 5 illustrates one example of a central processing unit for implementing a computer process in accordance with a computer implemented embodiment of the present invention;

FIG. 6 illustrates one example of a block diagram of internal hardware of the central processing unit of FIG. 5; and

FIG. 7 is an illustrative computer-readable medium upon which computer instructions can be embodied

### DETAILED DESCRIPTION

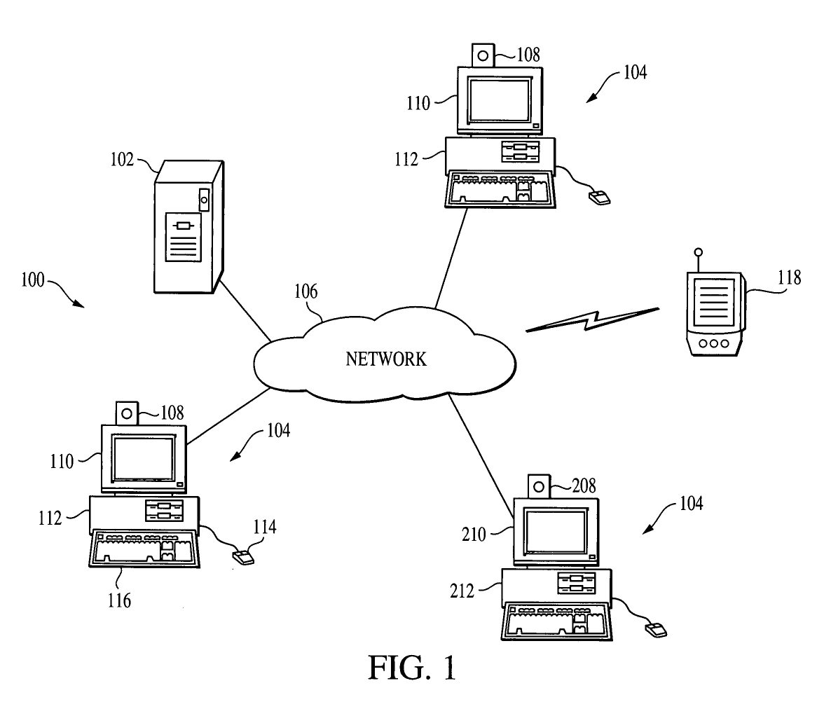

FIG. 1 is a schematic of a network that can be used in accordance with at least one embodiment of the present invention in which the system 100 comprises a server computer 102 operatively connected to, for example, one or more computer systems (e.g., a personal computer (PC)) 104 and/or mobile computing devices 118 such as a personal digital assistant (PDA)) via a network 106. The network 106 can be, for example, a Local Area Network (LAN), Wide Area Network (WAN), the Internet, or comprise any combination thereof.

The PCs 104 generally comprise an optical reader (e.g., a web/video camera and/or scanner) 108, a display monitor 110, a central processing unit 112 which can have one or more related devices (e.g., a hard drive, not shown), a mouse 114, and a keyboard 116. In at least one embodiment of the present invention, watermarking technology commercially available from Digimarc Corporation, Tualatin, Oreg., can be used. Specifically, Digimarc MediaBridge™ technology can be used to create an imperceptible digital watermark consisting, for example, Extensible Markup Language based (XML-based) coding embedded in a graphic or other media element. With the aid of an optical reader 108, Digimarc MediaBridge™ software reads the watermark, activates a standard Web browser (if not already activated), and delivers the user to a specified Web site. Examples of optical readers that can be used in conjunction with the present invention include web cameras manufactured by, for example, Philips CFT North America, Sunnyvale, Calif., International Business Machines, Armonk, N.Y., Intel Corporation, Santa Clara, Calif., and/or Logitech Inc., Fremont, Calif. Embodiments of the present invention also include the use of individual PCs 104 that are not linked to or connected to a network 106.

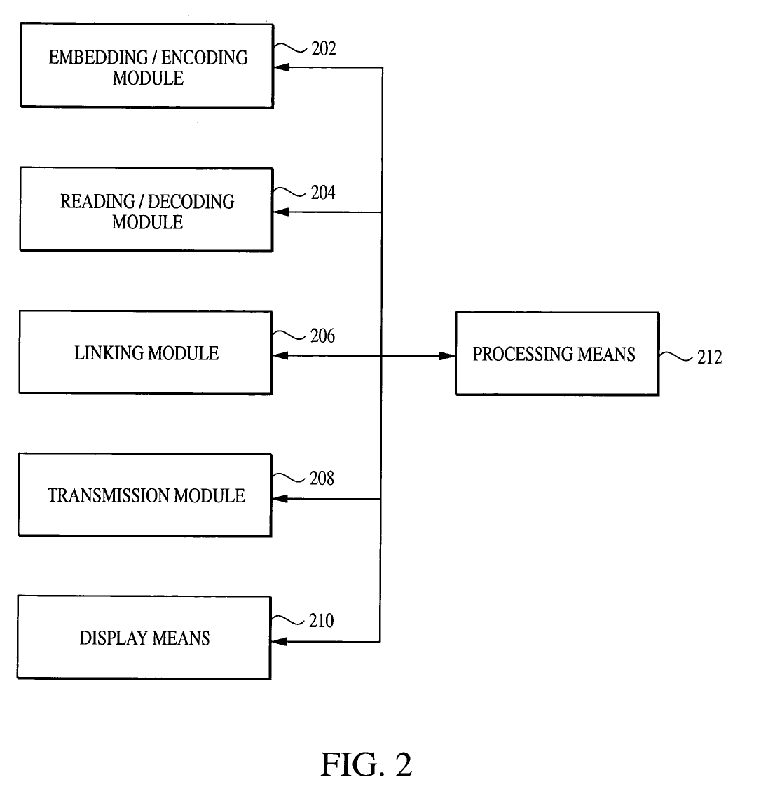

FIG. 2 is a schematic diagram of an imperceptible digital watermark-driven system according to a generalized embodiment of the present invention. Embedding/encoding module 202 can comprise a commercially available program that can be used to imperceptibly embed one or more digital watermarks into, for example, a picture/image on, for example, a page of text that is to be utilized in an academic and/or educational context. Reading/decoding module 204 can comprise a commercially available program that can use, for example, an optical reader 108 to retrieve the embedded code and act upon it. The Embedding/encoding module 202 and/or the reading/decoding module 204 can utilize, for example, the Digimarc MediaBridge™ software. The embedding/decoding module 202 and/or the reading/decoding module 204 can also utilize, for example, the system and/or method disclosed in U.S. Pat. Nos. 5,841,978 and 6,246,777, each of which are incorporated herein by reference.

Once the reading/decoding module 204 has read the embedded watermark, linking module 206 can correlate or direct the watermark to, for example, the URL or application program designated by the digital watermark. In at least one embodiment, when the embedded digital watermark comprises a URL (e.g., www.iaete.org) or path (e.g., C:/program files/excel.exe), the linking module can (if required) launch a browser (e.g., Netscape Communicator or Internet Explorer) and direct the browser to the web page associated with the embedded URL. The linking module 204 can comprise, for example, a file name or location within, for example, a database file that contains one or more URLs. This enables the user to modify a URL without changing the embedded watermark.

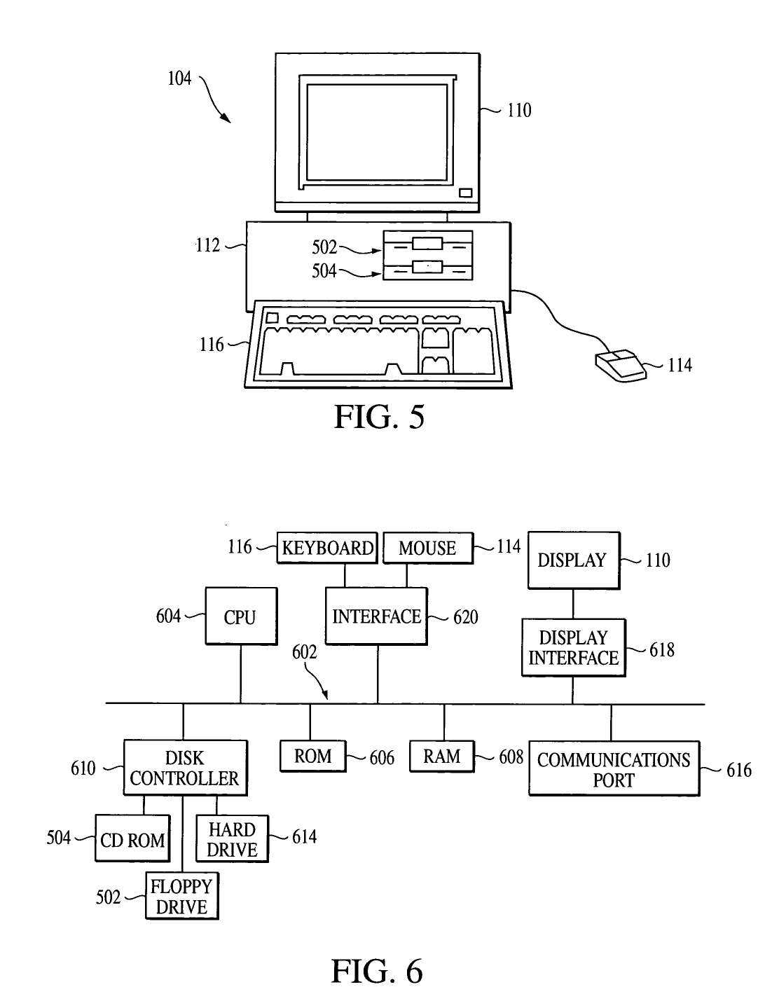

Transmission module 208 can comprise conventional hardware and/or software that enables a PC 104 to communicate with, for example another PC 104 and/or server computer 102 via a network 106. The display means can comprise, for example, a conventional monitor 110. A processing module, such as a central processing unit (CPU) 604 discussed with regard to FIG. 6 can be operatively connected to and/or communicable with any of modules 202-208 and/or display module 210 to facilitate operation thereof. Alternatively, any of modules 202-208 can have (or be associated with) their own processing modules.

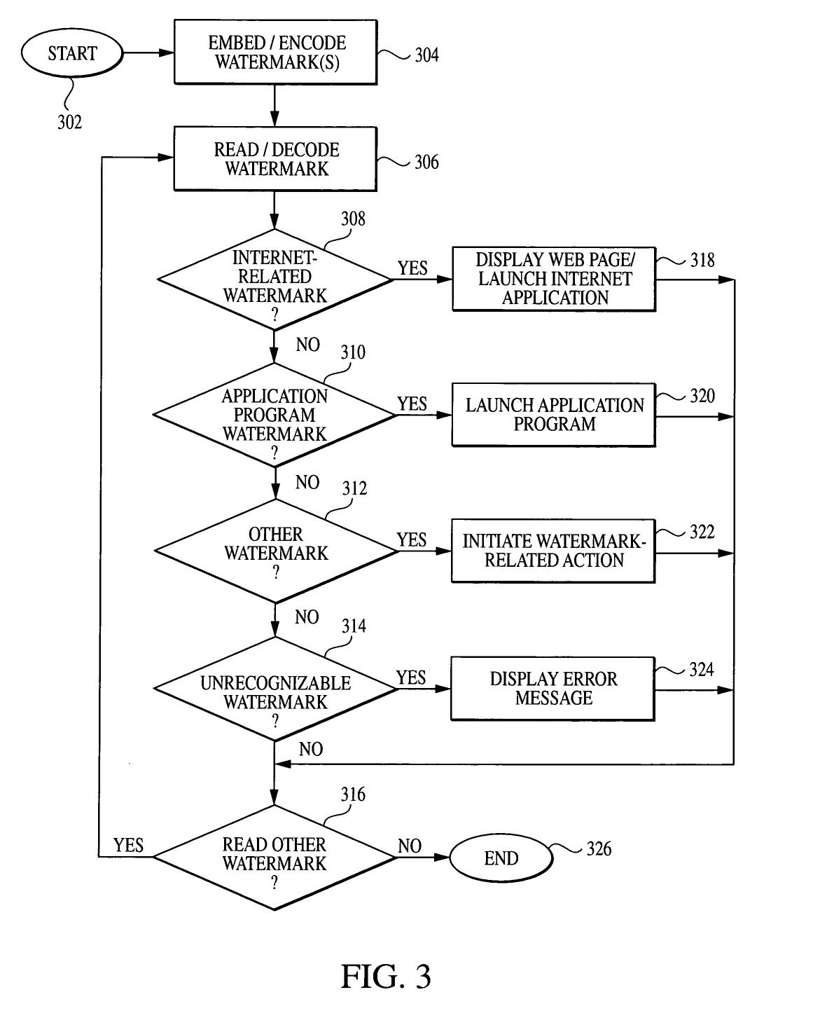

FIG. 3 is a flow chart setting forth the steps carried out during the execution of at least one embodiment of the present invention. After the process begins 302, at step 304 a user can use, for example, embedding/encoding module 202 to embed/encode a watermark in, for example, an image. At step 306, reading/decoding module 204 can be used to read/decode the embedded watermark. At decision step 308, a determination is made whether the watermark is an Internet-related watermark (e.g., a URL). If so, the Internet application can be launched at step 318. For example, if the watermark is a URL, the web page can be displayed via display monitor 110.

If a determination is made at decision step 308 that the watermark is not Internet-related, a determination is made at decision step 310 whether the watermark is related to an application program. As used herein, an application program can be any data entry, update, query or report program that processes data for the user, and can include generic productivity software (e.g., conventional spreadsheet, word processor, and/or database programs) as well as custom and packaged programs (e.g., an accounting program, an accommodation tool such as an application program for the hearing impaired, and/or program or instructional material used in conjunction with an Individualized Education Program (IEP)). If it is determined that the watermark pertains to an application program (e.g., C:\program files\wp.exe), the corresponding application program can be launched at step 320. If a determination is made at decision step 310 that the watermark does not pertain to an application program, a determination is made at decision step 312 whether the watermark is another type of recognized watermark. For example, the watermark can pertain to a utility program and/or educational assessment tool as previously described herein. As used herein, a utility program generally supports the use of the computer and/or mobile computing device and can provide, for example, file management capabilities (e.g., sorting, copying, comparing, listing and searching), as well as diagnostic and measurement routines that check the health and performance of the system. If it is determined that the watermark is, in fact, another type of recognized watermark, the corresponding application (e.g., a utility program or educational assessment tool) can be launched at step 322.

At decision step 314, a determination is made whether the embedded watermark is recognizable. If the watermark cannot be read, an error message can be displayed to the user. The inability to read the watermark may be due, for example, to the relative proximity and/or angle of the image containing the embedded watermark with respect to the optical reader 108 and/or the focus of the optical reader 108. After each of steps 318, 320, 322, and 324, a determination is made at decision step 316 as to whether the user wants to read another watermark. If so, the user can return to step 306. If not, the process ends at step 326.

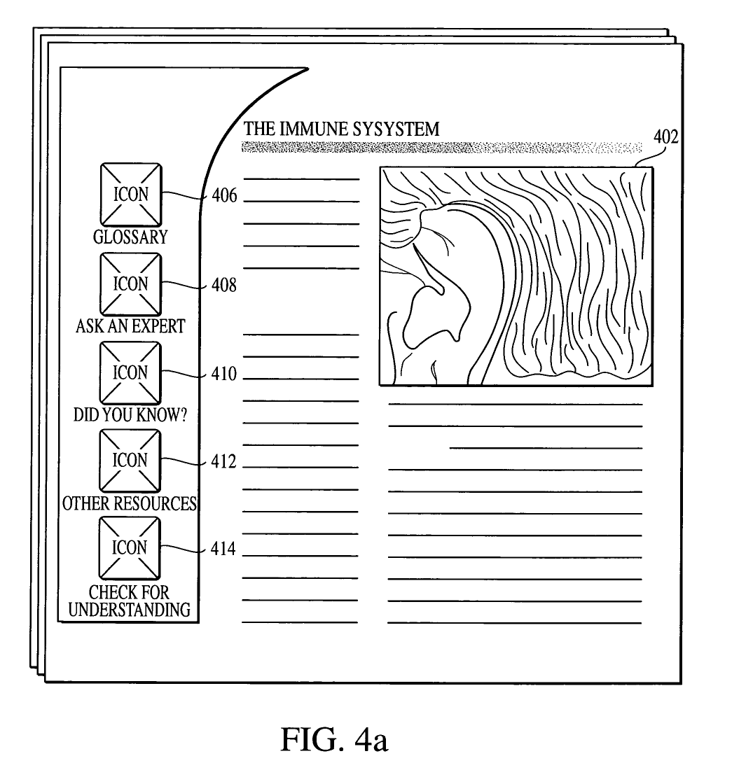

FIGS. 4A and 4B are illustrative pages of instructional material, and can be viewed as opposing pages of an interactive text. FIG. 4A contains an image 402 and a plurality of icons 406-414, and FIG. 4B contains an image 404, and a plurality if icons 416-432. Each image 402, 404 can be embedded with one or more digital watermarks that present to the user information associated with the watermark(s). The digital watermark can refer, for example, to a URL and/or a local or remote file. The URL and/or file(s) can be updated or modified to present the user with, for example, up-to-date and/or customized information.

For example, image 402 can have an embedded digital watermark of a first URL (e.g., www.hhmi.org/grants/lectures/biointeractive/vlabs/index.htm) that via use of, for example, an optical reader 108, takes the user to a website of the Howard Hughes Medical Institute that shows a bacterial identification lab. Similarly, image 402 can have, in addition to or as an alternative to the previously discussed digital watermark, an embedded digital watermark of a URL that via use of, for example, a web/video camera and/or scanner 108, takes the user to a website of the Centers for Disease Control and Prevention that tracks the impact of HIV/AIDS (e.g., www.cdc.gov/hiv/stats/hasrlink.htm). Advantageously, URLs can also and similarly be provided that direct a user to, for example, a website, network file and/or local file that provides to the user, for example, virtual lab experiences, animations, etc. that can be used to enhance and/or supplement the textbook learning experience.

Icons 406, 408, 410, 412, and 414 can have embedded therein one or more digital watermarks that can be used as previously discussed to, for example, launch additional resources, assessments, or other information. Each of icons 406-414 can also have one or more digital watermarks that take the user to, for example, a website, a local file (e.g., residing on a hard drive or CD-ROM), or a file residing on a network server 102. Further, the digital watermarks may be associated with either image 402 and/or 404 (shown in FIG. 4B), as well as with images and/or text of other pages (not shown). For example, icon 406 can have embedded therein a digital watermark (e.g., a URL) that can direct a user to web site (or to a file residing on a local hard drive, a floppy drive, a CD-ROM, or a network file) that contains a glossary that pertains to image 402, to image 404, or to both images 402, 404. Similarly, icon 408 can have an embedded digital watermark (e.g., a URL) that can take the user to a website where users can ask questions and/or have answers to commonly asked questions pertaining to the immune system and/or HIV and AIDS (e.g., Teens-Health Q&A (www.kidshealth.org/teen/question/index.html)).

Icon 410 can contain one or more digital watermarks pertaining to, for example, news stories about the immune system (e.g., www.microbe.org) and/or HIV and AIDS (e.g., www.journale.com/aidsdecade/). Icon 412 can have one or more digital watermarks pertaining to other general resources (e.g., www.refdesk.com) and/or resources pertaining to the immune system and/or HIV and AIDS (e.g., www.hivpositive.com). Icon 412 (and/or any other icon) can also provide a link that may be beneficial to the physically impaired. For example, icon 412 could provide a link to, for example, a URL or a local or remote file so that a hearing-impaired student studying composers might access different information (e.g., a visual pattern of repeating color that would represent tone) than students with unimpaired hearing.

Icon 414 can be used to launch, for example, an application program comprising a simple assessment (e.g., a series of text-based questions and/or a simulation allowing the student to respond to one or more questions, receive feedback, and/or allow an instructor or other individual to monitor student performance and adjust learning activities to individual performance.).

Referring now to FIG. 4B, icons 416, 418, 420, 422, 424, 426, 428, 430, and 432 can also have embedded therein one or more digital watermarks that can launch via use of, for example, an optical reader 108, a variety of tools and/or application programs from, for example, a local hard drive or from a server 102. For example, icon 416 can contain an embedded watermark of a sound tool application program (C:\program files\real\realplayer\realplay.exe) that, for example, enables a user to audibly hear a file containing data that can be audibly played back to the user. Icon 418 can contain a digital watermark of the path of an application program (e.g., Inspiration and/or Kidspiration programs by Inspiration Software, Inc., Portland, Oreg.) that enables a user to dynamically create and modify concept maps, flow charts and other graphical organizers for, e.g., visual learners.

Icon 420 can contain a digital watermark of the path of a database application program (e.g., Microsoft Access, by Microsoft Corporation, Redmond, Wash.), whereas icon 422 can contain a digital watermark of the path of a text editor (e.g., Notepad within Microsoft Windows). Further, icon 424 can contain a digital watermark of, for example, an e-mail program (e.g., Microsoft Outlook), and icon 426 can contain a digital watermark of, for example, the path of a graphics editor (e.g., Photoshop, by Adobe Systems Incorporated, San Jose, Calif.).

Icon 428 can contain an embedded watermark of the path of an application program (e.g., Microsoft PowerPoint) that enables a user to create and/or modify text and/or graphical presentations. Icon 430 can contain an embedded watermark of the path of a spreadsheet application program (e.g., Microsoft Excel).

Finally, icon 432 can contain a digital watermark of the path of a web browser (e.g., Netscape Communicator, by Netscape Communications, Mountain View, Calif.) that enables the user to view the web page(s) associated with any URL(s) that may be embedded in an image (e.g., 402, 404) and/or icon (e.g., 406-430, and/or 432).

It should be understood that FIGS. 4A and 4B are illustrative only, and that other icons can be provided in addition to or in lieu of icons 406-432 that that can be used to launch one or more application programs that, as previously discussed, accommodate the physically disabled and/or that are associated with some educational function or plan (e.g., an IEP).

In view of the foregoing, it is important to note that this interactivity is an extension of text information. Any function now possible on the WWW, including a substantially realtime conferencing capability between two or more users of at least one of a local area network (LAN), a wide are network (WAN), a bulletin board system (BBS) and the Internet, data visualization, simulations and virtual reality environments is contemplated within the context of the interactive instructional material.

### Computer Implementation

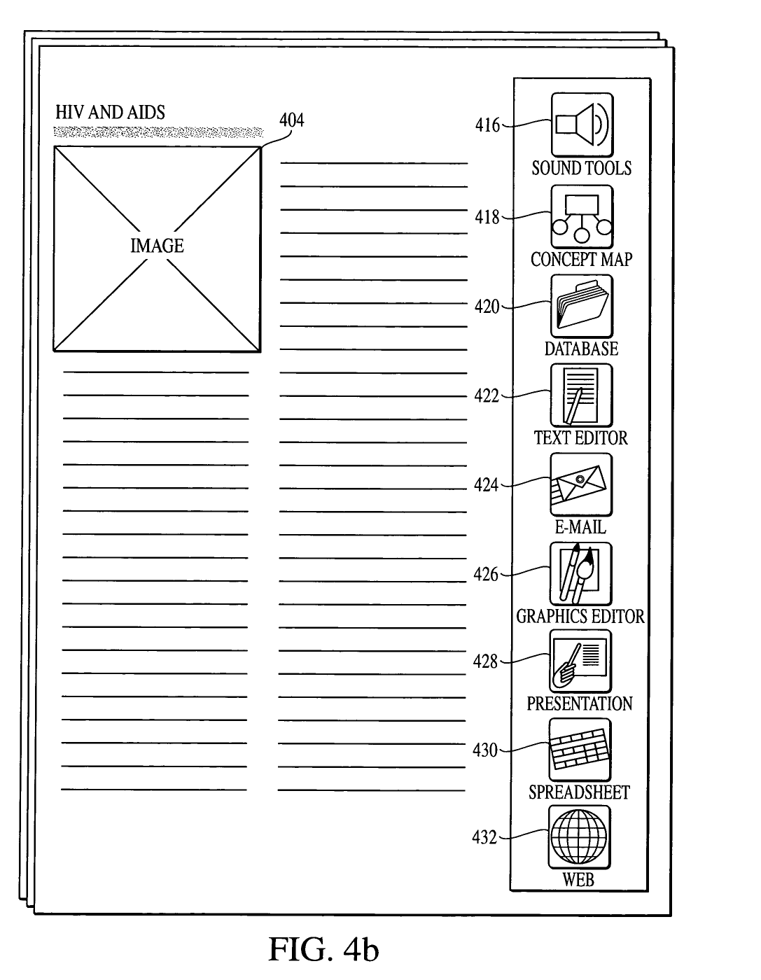

The techniques of the present invention may be implemented on a computing unit such as that depicted in FIG. 5. In this regard, FIG. 5 is an illustration of a computer system 104 which is also capable of implementing some or all of the computer processing in accordance with at least one computer implemented embodiment of the present invention. The procedures described herein are presented in terms of program procedures executed on, for example, a computer or network of computers and/or mobile computing devices (as shown, for example, in FIG. 1).

Viewed externally, in FIG. 5, a computer system designated by reference numeral 104 has a computer portion 112 having drives 502 and 504, which are merely symbolic of a number of disk drives which might be accommodated by the computer system. Typically, these could include a floppy disk drive 502, a hard disk drive (not shown externally) and a CD ROM 504. The number and type of drives vary, typically with different computer configurations. Disk drives 502 and 504 are in fact optional, and for space considerations, are easily omitted from the computer system used in conjunction with the production process/apparatus described herein.

The computer system 104 also has an optional display 110 upon which information, such as a web page and/or application program associated with any of the one or more digital watermarks embedded in images 402, 404 and/or icons 406-432, may be displayed. In some situations, a keyboard 116 and a mouse 114 are provided as input devices through which input may be provided, thus allowing input to interface with the central processing unit 604. Then again, for enhanced portability, the keyboard 116 is either a limited function keyboard or omitted in its entirety. In addition, mouse 114 optionally is a touch pad control device, or a track ball device, or even omitted in its entirety as well, and similarly may be used as an input device. In addition, the computer system 104 may also optionally include at least one infrared (or radio) transmitter and/or infrared (or radio) receiver for either transmitting and/or receiving infrared signals.

Although computer system 104 is illustrated having a single processor, a single hard disk drive and a single local memory, the system 104 is optionally suitably equipped with any multitude or combination of processors or storage devices. Computer system 104 is, in point of fact, able to be replaced by, or combined with, any suitable processing system operative in accordance with the principles of the present invention, including hand-held, laptop/notebook, mini, mainframe and super computers, as well as processing system network combinations of the same.

FIG. 6 illustrates a block diagram of the internal hardware of the computer system 104 of FIG. 5. A bus 602 serves as the main information highway interconnecting the other components of the computer system 104. CPU 604 is the central processing unit of the system, performing calculations and logic operations required to execute a program. Read only memory (ROM) 606 and random access memory (RAM) 608 constitute the main memory of the computer 104. Disk controller 610 interfaces one or more disk drives to the system bus 602. These disk drives are, for example, floppy disk drives such as 502, CD ROM or DVD (digital video disks) drive 504, or internal or external hard drives 614. As indicated previously, these various disk drives and disk controllers are optional devices.

A display interface 618 interfaces display 110 and permits information from the bus 602 to be displayed on the display 110. Again as indicated, display 110 is also an optional accessory. For example, display 110 could be substituted or omitted. Communications with external devices, for example, the other components of the system described herein, occur utilizing communication port 616. For example, optical fibers and/or electrical cables and/or conductors and/or optical communication (e.g., infrared, and the like) and/or wireless communication (e.g., radio frequency (RF), and the like) can be used as the transport medium between the external devices and communication port 616. Peripheral interface 620 interfaces the keyboard 116 and the mouse 114, permitting input data to be transmitted to the bus 602.

In alternate embodiments, the above-identified CPU 604, may be replaced by or combined with any other suitable processing circuits, including programmable logic devices, such as PALs (programmable array logic) and PLAs (programmable logic arrays). DSPs (digital signal processors), FPGAs (field programmable gate arrays), ASICs (application specific integrated circuits), VLSIs (very large scale integrated circuits) and the like.

Any presently available or future developed computer software language and/or hardware components can be employed in such embodiments of the present invention. For example, at least some of the functionality mentioned above could be implemented using Extensible Markup Language (XML), HTML, Visual Basic, C, C++, or any assembly language appropriate in view of the processor(s) being used. It could also be written in an interpretive environment such as Java and transported to multiple destinations to various users.

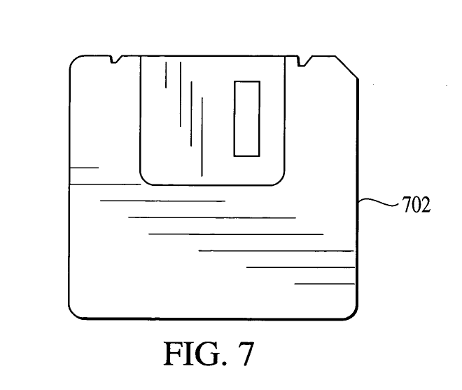

One of the implementations of the invention is as sets of instructions resident in the random access memory 608 of one or more computer systems 104 configured generally as described above. Until required by the computer system, the set of instructions may be stored in another computer readable memory, for example, in the hard disk drive 614, or in a removable memory such as an optical disk for eventual use in the CD-ROM 504 or in a floppy disk (e.g., floppy disk 702 of FIG. 7) for eventual use in a floppy disk drive 502. Further, the set of instructions (such as those written in Java, HTML, XML, Standard Generalized Markup Language (SGML), and/or Structured Query Language (SQL)) can be stored in the memory of another computer and transmitted via a transmission medium such as a local area network or a wide area network such as the Internet when desired by the user. One skilled in the art knows that storage or transmission of the computer program medium changes the medium electrically, magnetically, or chemically so that the medium carries computer readable information.

The many features and advantages of the invention are apparent from the detailed specification, and thus, it is intended by the appended claims to cover all such features and advantages of the invention which fall within the true spirit and scope of the invention. Further, since numerous modifications and variations will readily occur to those skilled in the art, it is not desired to limit the invention to the exact construction and operation illustrated and described, and accordingly, all suitable modifications and equivalents may be resorted to, falling within the scope of the invention. While the foregoing invention has been described in detail by way of illustration and example of preferred embodiments, numerous modifications, substitutions, and alterations are possible without departing from the scope of the invention defined in the following claims.

Having thus described our invention, what we claim as new and desire to secure by Letters Patent is as follows:

1. A computer-implemented and user assisted method for accessing data stored on a storage medium, comprising the steps of:
creating an object on a physical page of instructional material used in and/or in connection with an academic and/or educational context, the object having steganographically embedded indicia for accessing at least a portion of the data;
electronically reading the indicia from the physical page;
transmitting the electronically read indicia to the computer; and
transmitting the data that is associated with the indicia from the storage medium to an output device in communication with the computer.

2. The method of claim 1, wherein the output device is a display monitor.

3. The method of claim 1, wherein the output device is a speaker.

4. The method of claim 1, wherein the indicia comprises at least one of a path and a Uniform Resource Locator (URL).

5. The method of claim 1, wherein the data comprises at least one of an application program, audible content, graphic content, text content, and/or a web page.

6. A computer-implemented and user assisted method for accessing data stored on a storage medium associated with an object on a page of instructional material used in and/or in connection with an academic and/or educational context, comprising the steps of:
creating an object on a page of instructional material used in and/or in connection with an academic and/or educational context, the object having steganographically embedded indicia for accessing at least a portion of the data stored on a storage medium in communication with the computer;
electronically reading the indicia;
transmitting the electronically read indicia to the computer; and
using the indicia to access at least a portion of the data stored on a storage medium associated with the computer.

7. The method of claim 6, wherein the indicia comprises at least one of a path and a Uniform Resource Locator (URL).

8. The method of claim 6, wherein the data comprises at least one of an application program, audible content, graphic content, text content, and/or a web page.

9. The method of claim 6, further comprising the step of displaying the data via a display device in communication with the computer.

10. The method of claim 6, further comprising the step of audibly outputting the data via a speaker in communication with the computer.

11. A computer-implemented and user assisted method for initiating an action based upon reading steganographically embedded indicia on a physical page of instructional material used in and/or in connection with an academic and/or educational context, comprising the steps of:
creating an object on a physical page of instructional material having steganographically embedded indicia;
electronically reading the indicia from the physical page; and
using the indicia to initiate an action from the computer as determined by the steganographically embedded indicia.

12. The method of claim 11, wherein the indicia comprises a path.

13. The method of claim 11, wherein the action comprises launching an application program.

14. The method of claim 11, wherein the action comprises accessing a file residing on a storage medium associated with the computer.

15. A computer-implemented and user assisted method of using a first computer to access information stored on and/or in connection with a second computer, comprising the steps of:
creating an object on a physical page of instructional used in and/or in connection with an academic and/or educational context, the object having steganographically embedded indicia for accessing at least a portion of the information stored on and/or in connection with the second computer;
electronically reading the indicia from the physical page;
transmitting the electronically read indicia to the first computer; and
transmitting via the network the information stored at the second computer that is associated with the indicia to the first computer.

16. The method of claim 15, further comprising the step of at least one of displaying and audibly outputting the data at the first computer.

17. The method of claim 15, wherein the indicia is at least one of a path and a Uniform Resource Locator (URL).

18. A computer-implemented and user assisted method of using a first computer to access data associated with an object on a physical page of instructional material used in and/or in connection with an academic and/or educational context, comprising the steps of:
creating an object having steganographically embedded indicia on a physical page of instructional material;
electronically reading the indicia from the physical page; and
using the indicia to access at least a portion of the data stored on a storage medium associated with the computer.

19. The method of claim 18, further comprising the step of at least one of displaying and audibly outputting the data.

20. An interactive physical medium used in and/or in connection with an academic and/or educational context, the interactive physical medium comprising:
at least one object on at least one physical page of the interactive physical medium; and
steganographic indicia embedded in one or more of said at least one object, said steganographic indicia facilitating electronic access to data associated with said steganographic indicia stored on a storage medium in communication with the computer.

21. The interactive physical medium of claim 20, wherein the indicia comprises at least one of a path and a Uniform Resource Locator (URL).

22. The interactive physical medium of claim 20, wherein the electronic access is to at least one of an application program, audible content, graphic content, text content, and a web page.

23. The interactive physical medium of claim 22, wherein the electronic access facilitates at least one of displaying and audibly outputting the data via the computer.

24. The interactive physical medium of claim 20, wherein the data comprises a substantially realtime conferencing capability between two or more users of at least one of a local area network (LAN), a wide are network (WAN), a bulletin board system (BBS), and the Internet.

25. An interactive physical medium used in and/or in connection with an academic and/or educational context comprising:
at least one object on at least one physical page of the physical medium; and
steganographic indicia embedded in one or more of said at least one object, said steganographic indicia capable of being electronically read by a device in communication with a first computer thereby facilitating electronic access to data stored on at least one of the first computer and a second computer associated with the steganographic indicia.

26. The interactive physical medium of claim 25, wherein the data stored at the second computer is outputted via at least one of a display device and an speaker in communication with the first computer.

27. The interactive physical medium of claim 25, wherein the indicia comprises at least one of a path and a Uniform Resource Locator (URL).

28. The interactive physical medium of claim 25, wherein the electronic access is to at least one of an application program, audible content, graphic content, text content, and a web page.

29. The interactive physical medium of claim 25, wherein the data is stored in a file residing on a storage medium in communication with at least one of the first computer and the second computer.

30. A system for using a computer to access data associated with an object on a physical page of instructional material used in and/or in connection with an academic and/or educational context, comprising:
an embedding module for steganographically embedding indicia in an object on the physical page of instructional material;
an optical reader for electronically reading the indicia;
a decoding module for decoding the indicia received as input from said optical reader;
a linking module receiving input from said decoding module, said linking module initiating action associated with the indicia;
a transmission module transmitting content associated with the indicia to an output device in communication with the computer; and
an output module for transmitting the content associated with the indicia to the output device.

31. The system of claim 30, wherein the indicia comprises at least one of a path and a Uniform Resource Locator (URL).

32. The system of claim 30, wherein the action comprises at least one of launching an application program, rendering audible output from an audio file, and accessing a web page.

33. The system of claim 30, wherein the action comprises at least one of accessing a file residing on a storage medium associated with the computer and accessing a file residing on a storage medium associated with a remote computer in communication with the computer via a network.

34. The system of claim 30, wherein the action comprises initiating a substantially realtime conferencing capability between two or more users of at least one of a local area network (LAN), a wide are network (WAN), a bulletin board system (BBS), and the Internet.

35. The system of claim 30, wherein the action comprises connecting to an audio file and audibly transmitting the contents of the audio file to the user.

36. The system of claim 30, wherein the action is connecting to an audio file and audibly outputting the contents of the audio file.

37. The system of claim 30, wherein the data is transmitted from a second computer to the computer via a network.

38. A system for using a computer to access data associated with an object on a physical page of instructional material used in and/or in connection with an academic and/or educational context, comprising:
means for steganographically embedding an indicia in an object on the physical page of instructional material;
an optical reader for electronically reading the indicia;
means for decoding the indicia received as input from said optical reader;
linking means for receiving input from said decoding means, said linking means initiating action associated with the indicia;
transmission means for transmitting content associated with the indicia to an output device in communication with the computer; and
output means for visibly displaying and/or audibly providing the content associated with the indicia to a user.

39. The system of claim 38, wherein the indicia comprises at least one of a path and a Uniform Resource Locator (URL).

40. The system of claim 38, wherein the action comprises at least one of launching an application program, rendering audible output from an audio file, and accessing a web page.

41. The system of claim 38, wherein the action comprises at least one of accessing a file residing on a storage medium associated with the computer and accessing a file residing on a storage medium associated with a remote computer in communication with the computer via a network.

42. The system of claim 38, wherein the action comprises initiating a substantially realtime conferencing capability between two or more users of at least one of a local area network (LAN), a wide are network (WAN), a bulletin board system (BBS), and the Internet.

43. The system of claim 38, wherein the action comprises connecting to an audio file and audibly transmitting the contents of the audio file to the user.

44. The system of claim 38, wherein the action is connecting to an audio file and audibly outputting the contents of the audio file.

45. The system of claim 38, wherein the data is transmitted from a second computer to the computer via a network.

46. The system of claim 38, wherein the data is transmitted from a second computer to the computer via a network.

47. A computer program medium storing computer instructions therein for instructing a computer to access data associated with an object on a physical page of instructional material used in and/or in connection with an academic and/or educational context, the medium comprising:
first instructions for steganographically embedding an indicia in an object on the physical page of instructional material;
second instructions electronically reading the indicia;
third instructions for decoding the indicia received as input from said second instructions;
fourth instructions for receiving input from said third instructions, said fourth instructions initiating action associated with the indicia; and
fifth instructions for transmitting content associated with the indicia to an output device in communication with the computer.

48. The medium of claim 47, wherein the indicia comprises at least one of a path and a Uniform Resource Locator (URL).

49. The medium of claim 47, wherein the action comprises at least one of launching an application program, rendering audible output from an audio file, and accessing a web page.

50. The medium of claim 47, wherein the action comprises at least one of accessing a file residing on a storage medium associated with the computer and accessing a file residing on a storage medium associated with a remote computer in communication with the computer via a network.

51. The medium of claim 47, wherein the action is initiating a substantially realtime conferencing capability between two or more users of at least one of a local area network (LAN), a wide are network (WAN), a bulletin board system (BBS), and the Internet.

52. The medium of claim 47, wherein the action is connecting to an audio file and audibly outputting the contents of the audio file.

53. The medium of claim 47, wherein the data is transmitted from a second computer to the computer via a network.

54. A computer-implemented and user assisted method for accessing data stored on a storage medium, comprising the steps of:
creating an object on a physical page of instructional material used in and/or in connection with an academic and/or educational context, the object having at least one of imperceptible and substantially imperceptible embedded indicia comprising at least one of a path and a Uniform Resource Locator (URL) for accessing at least a portion of the data;
electronically reading the indicia from the physical page;
transmitting the electronically read indicia to the computer; and
transmitting the data that is associated with the indicia from the storage medium to at least one of a display monitor and a speaker in communication with the computer.
